(19) United States
(12) Patent Application Publication
(10) Pub. No.: US 2020/0326064 A1
(43) Pub. Date: Oct. 15, 2020

(54) LIGHTING APPARATUS HOUSING

(71) Applicants: Simon Cadisch, Hertfordshire (GB); Ecoled Ltd., Hertfordshire (GB)

(72) Inventors: Simon Cadisch, Hertfordshire (GB); Alexander William Pringle Winship, Hertfordshire (GB)

(73) Assignees: Simon Cadisch, Hertfordshire (UK); Ecoled Ltd., Hertfordshire (GB)

(21) Appl. No.: 16/847,751

(22) Filed: Apr. 14, 2020

(30) Foreign Application Priority Data
Apr. 15, 2019 (GB) 1905334.7

(51) Int. Cl. F21V 29/71; F21V 29/78; F21V 29/77; F21V 15/01

(52) U.S. Cl. CPC F21V 29/713; F21V 29/78; F21Y 2115/10; F21V 15/01; F21V 29/773

(57) ABSTRACT

A housing for a lighting apparatus has body with a light beam channel and a light source leading to a mouth through the channel and, formed integrally with the housing body and disposed at a back portion of the housing body, a heat transfer region, with at least a portion of the housing body is formed of forged metal. The housing body includes a core body member and a shell body member A light beam channel is defined by an internal surface of the core body member, and a light source or light source mount therein. A core heat transfer region is present in the core body. The shell body member includes an aperture for securely receiving the core body member and includes a shell heat transfer region.

### RELATED APPLICATIONS

This application claims priority benefit of UK patent application No. 1905334.7 having a filing date of Apr. 15, 2019, the contents of which are hereby incorporated by reference.

### FIELD OF THE INVENTION

This invention relates to the field of light fittings. More particularly, it relates to a housing for a lighting apparatus having improved thermal heat dissipation and a lighting system incorporating such a housing and to a method of manufacturing the same.

### BACKGROUND OF THE INVENTION

Lighting systems for directed spotlight illumination utilise light sources that generate heat. Even with low power light emitting diodes (LED) over half of the electricity becomes heat rather than light. If the heat is not removed at a sufficient rate but instead is retained within the LED housing, the LEDs run at higher temperature which not only reduces their efficiency but also reduces the reliability and LED life. For this reason, the thermal management of the housing containing the LED light source must be designed to limit the allowable LED temperature to a value that will allow a guarantee for desired light source lifetime. This is especially challenging in more complex designs which are intended to deliver functional benefits such as simple installation, reduced visual impact and highly adjustable over a wide degree of illumination angle. Transport of heat from the LED source is achievable with heatsinks. Heat sinks of larger surface area are capable of greater heat transport and higher thermal performance, but the housings are consequently of greater bulk and weight, less aesthetically pleasing and higher material cost. Heatsinks are typically fixed to the housing or LED/light source body. The fixing location creates increased thermal transport resistance at the housing bonding joints and the constant cross section extrusions provide limitations in freedom of design and consequent aesthetic appeal.

### PROBLEM TO BE SOLVED BY THE INVENTION

There is a need for a lighting apparatus housing, such as for a spot lighting system, which has an improved thermal dissipation of light source heat, and a method of manufacturing which allows design freedom for varied functional and aesthetic qualities.

It is an object of this invention to provide a lighting apparatus which has improved thermal dissipation of light source heat and which can thereby extend the lifetime of the light source due to lower light source running temperatures or increase the power of the light source that may be fitted.

### SUMMARY OF THE INVENTION

In accordance with a first aspect of the invention, there is provided a housing for a lighting apparatus, the housing having a housing body comprising a light beam channel for the passage of light from a light source through the housing to a mouth, the light beam channel being defined by an internal surface of the housing body, the housing having a light source or a light source mount within the light beam channel, wherein the housing body has a front portion proximal to the mouth and a back portion distal from the mouth and, formed integrally with the housing body and disposed at a back portion of the housing body, a heat transfer region, wherein at least a portion of the housing body is formed of forged metal.

In a second aspect of the invention, there is a housing for a lighting apparatus, the housing having a housing body, wherein the housing body comprises a core body member and a shell body member, wherein the core body member comprises a light beam channel for the passage of light from a light source through the housing to a mouth, which light beam channel is defined by an internal surface of the core body member, the core body member having a light source or light source mount within the light beam channel and a core heat transfer region and wherein the shell body member comprises an aperture for securely receiving the core body member and comprises a shell heat transfer region.

In a third aspect of the invention, there is a method of manufacturing a housing as defined above, the method comprising providing a die or mould shaped to form a moulded article corresponding to the housing, providing a metal blank and subjecting the metal blank to compressive force so as to form a housing article according to the shape of the die or mould.

In a fourth aspect of the invention, there is a lighting apparatus, such as a spotlight, comprising a housing as defined above.

### ADVANTAGES OF THE INVENTION

The forged metal housing body with integral heat transfer region and core-shell housing arrangement of the housing and lighting apparatus of the present invention enable manufacture of lighting apparatus housings with a greater range of designs and functional benefits, especially for use as spotlights, which are efficiently manufactured and provide excellent thermal dissipation performance

### BRIEF DESCRIPTION OF THE DRAWINGS

FIGS. 1a, 1b and 1c are back perspective, front perspective and side exploded views of a housing body in accordance with one embodiment of the invention;

FIGS. 2a and 2b are back perspective and side views of assembled housing body according to one embodiment of the invention;

FIG. 3 is a back perspective view of part of a lighting apparatus of one embodiment of the invention;

FIG. 4 is a front perspective exploded view of the lighting apparatus of FIG. 3; and

FIG. 5 is a cross-sectional view of a lighting apparatus of one embodiment of the present invention.

### DETAILED DESCRIPTION OF THE INVENTION

A housing for a lighting apparatus and a lighting apparatus comprising the housing are described. The housing has a housing body comprising a light beam channel for the passage of light from a light source through the housing to a mouth, the light beam channel being defined by an internal surface of the housing body. The housing has a light source or a light source mount within the light beam channel. The housing body has a front portion proximal to the mouth and a back portion distal from the mouth. Formed integrally with the housing body and disposed at a back portion of the housing body is a heat transfer region.

At least a portion of the housing body and preferably all of the housing body is formed of forged metal. Preferably, at least a portion and preferably all of the housing body is formed of cold forged metal. The metal may be any suitable metal or alloy suitable for cold forging, but is preferably aluminium. Preferably, the aluminium is a pure or rolled aluminium, such as 6063 Aluminium or 1070 Aluminium and most preferably is 1070 Aluminium (A199.7).

n a preferred embodiment of the invention and in another aspect of the invention, a housing for a lighting apparatus has a housing body, wherein the housing body comprises a core body member and a shell body member. The core body member comprises a light beam channel for the passage of light from a light source through the housing to a mouth, which light beam channel is defined by an internal surface of the core body member which is the internal surface of the housing body defined above. The core body member preferably has a light source or light source mount within the light beam channel. The core body member preferably has a core heat transfer region and the shell body member preferably comprises a shell heat transfer region.

According to this aspect/embodiment, the shell body member defines an aperture for securely receiving the core body member.

The shell body member and core body member preferably maintain intimate contact when the core body member is received by the shell body member, particularly in a distal portion or toward a distal end of the core body member or light beam channel formed therein and in any case preferably in the portion of the core body member in which a light source (e.g. LED) may be mounted.

Preferably, the aperture of the shell body member defines a shell inner surface configured to cooperate with a core outer surface of the core body member preferably to facilitate a contact fit between the core body member and the shell body member.

The core body member may have any suitable shape for fitting into the aperture of the shell body member. At least a portion of the core body member may comprise a prismic or a pyramidal/conical or truncated pyramidal/conical shape. A prismic shape or a pyramidal/conical (or truncated pyramidal/conical) shape may any suitable such shape, such as octagonal, heptagonal, hexagonal, pentagonal, rectangular square prism or triangular or the prism may be a cylindrical shape and the pyramid/cone may be a conical (or truncated conical) shape. Preferably, a prismic shape forming at least a portion of the core body member is a cylindrical prism. A portion of a core body member may comprise a prismic shape and a portion may comprise a truncated pyramidal or conical shape, for example a proximal portion may be prismic (e.g. cylindrical) and a distal portion may be truncated pyramidal (e.g. truncated cone) or vice versa. Optionally, the core body member comprises a proximal truncated pyramidal or conical portion and a distal truncated pyramidal or conical portion and an intermediate prismic (e.g. cylindrical) portion, or vice versa. Most preferably, the core body member is generally cylindrical.

The light source or light source mount may be disposed at any location within the light beam channel formed within the housing (and, in embodiments having a core body member, within the core body member) and preferably the light source or light source mount is disposed at an opposite end of the channel from the mouth. The opposite end of the channel (which may be a closed channel) may be in the interior of the housing, e.g. in a middle portion, such as a middle third (from front to back).

Preferably, the path of the light beam channel from light source or light source mount defines a longitudinal axis of the housing body (and a core body member).

The heat transfer region or regions preferably comprise heat transfer members, such as fins and/or rods, separated by air gaps to provide enhanced heat transfer surface area and to facilitate convective cooling. Preferably, the heat transfer regions comprise planar fins or curved or undulating fins.

Heat transfer members making up the heat transfer region according to one embodiment have peripheral ends or surfaces which preferably define an outer surface of a back portion of the housing body. The heat transfer members thus preferably form part of the housing body. In the case of a spotlight lighting apparatus, the heat transfer members are preferably a part of the visible housing of the spotlight.

Preferably, the heat transfer region extends to a distal end of the housing body from a position closer to the mouth than the light source or light source mount is from the mouth. More preferably, the heat transfer region comprises fins that extend from a position closer to the mouth than the light source or light source mount is from the mouth.

More preferably, where the path of the light beam channel defines a longitudinal axis of the housing body (and a core body member), the heat transfer region extends from a portion of the housing body transverse to the light beam channel and in thermal connection with the internal surface of the housing body defining the light beam channel to a distal end of housing body distal to the mouth of the light beam channel. According to this embodiment, heat generated by the light source, such as LED, can be dissipated directly backward (toward the back of the housing) through a light source mount and is drawn away by the heat transfer members of the heat transfer region (or heatsink) which itself loses heat to the environment (by way of its large surface area fins). In the case of the housing which has a core body member in which the light beam channel is formed and housing the light source or light source mount, the heat may dissipate through the back of the core body member and be drawn away by the core heat transfer region which preferably comprises fins or rods integrally formed with the core body member. Further, heat generated by the light source may be dissipated transversely from within the light beam channel through the internal surface of the housing (and of the core body member where present). Such heat may dissipate into the solid body of the housing body and then be drawn back into heat transfer members (acting as a heat sink). The efficiency of this process is enhanced in a preferred embodiment where (especially in the core-shell arrangement) the heat transfer region (and heat transfer members making up the heat transfer region) extends sufficiently far forward (toward the mouth) as to be disposed as part of the housing lateral or transverse to the light beam channel. In the case of embodiments having a housing body formed of a core body member and a shell body member, the core body member and shell body member are preferably in intimate thermal contact in those regions where thermal dissipation is required such as transverse to a back portion of the light beam channel. Accordingly, heat transfer members or fins of a shell body member may preferably be in direct contact with an outer surface of the core body member to enhance that heat dissipation function.

Heat generated in the housing by the light unit may typically be drawn by thermal conductivity toward the heat transfer region (or heat sink zone) and into the heat transfer members whereupon the heat may be removed by convective air movement. The heat transfer region preferably comprises ventilation openings that may be grooved, defining fins, for example, and of sufficient size to enable maximum convective air flow.

Preferably, the heat transfer comprises a plurality of substantially parallel fins. Preferably, there are at least four fins, optionally up to ten, e.g. six to eight. The fins are preferably formed of aluminium.

Preferably, in an embodiment in which the housing body comprises a core body member and a shell body member, the shell heat transfer region extends toward the front so that it is disposed laterally to the light beam channel along at least 15% of the extent of the light beam channel (from light source to mouth), more preferably at least 20%, still more preferably at least 25% and more preferably still at least 30%.

Preferably, at least one third of the extent of the housing body from front (proximal to the mouth) to back (distal to the mouth) comprises heat transfer members such as fins or rods, preferably made of metal, such as aluminium. More preferably, at least half of the extent of the housing body comprises heat transfer members.

Preferably, at least 25% of the volume of the housing body makes up the heat transfer region and preferably comprises heat transfer members, such as fins or rods, more preferably at least 30% of the volume (such as at least 40% or at least 50%) and more preferably still from 40 to 60%.

In the case of a housing body comprising a core body member and a shell body member, the core heat transfer region is preferably integrally formed with the core body member and the shell heat transfer region is preferably integrally formed with the shell body member.

The shell body member and/or the core body member, at least, may preferably formed of forged metal (and preferably cold forged metal), such as aluminium and more preferably from cold forged 1070 Aluminium (A199.7). The core body member may be formed by any suitable arrangement and configured to cooperate with the shell body member so as to be received by the shell body member to form a housing body, wherein the core body member may be removably inserted into an aperture of the shell body member or fixedly and irremovable inserted (e.g. fused) therein. Preferably, the core body member is formed of forged metal (and preferably cold forged metal), such as aluminium and preferably 1070 Aluminium (A199.7).

The high thermal transfer performance of the assembly of such a core body member and shell body member in a housing body of a preferred embodiment enables greater freedom of design, including complex shape profiles for the lighting apparatus as a whole whilst retaining excellent thermal performance characteristics. By providing a core-shell arrangement and utilising cold-forging which allows the use of the 1070 Aluminium (A199.7) grade, design freedom of the configuration of the housing is widened allowing a design of preferred embodiments of the invention whilst retaining thermal dissipation performance due to the enhanced conductivity of the preferred cold forged metal.

The housing and housing body of the present invention may be any suitable shape and configuration.

In one preferred embodiment, the housing body comprises at least a curved outer surface portion. More preferably, the housing is shaped so that it has an expanded waist portion (e.g. between the front and pack portions). Preferably, the housing is at least partially spherical, preferably a truncated sphere, the truncated sphere generally comprising as sphere truncated at the mouth of the light beam channel. According to this preferred embodiment, the width (or maximum diameter) of the light beam channel is preferably at least 10% of the maximum width (or diameter) of the housing body, more preferably at least 25%, more preferably at least 30% and most preferably from 40 to 60%. Preferably, in embodiments in which the housing body is made of a core body member and a shell body member, the core body member has a width of at least 10% of the maximum width (or diameter) of the shell body member, more preferably at least 25%, more preferably at least 30% and most preferably from 40 to 60%.

The light source is preferably an LED.

A lighting apparatus according to another aspect of the invention comprising a housing as defined herein. Preferably, the lighting apparatus comprises a housing having a housing body as defined herein and a lighting mount for securing the lighting apparatus to a support or substrate and optionally a coupling mechanism for coupling the housing to the lighting mount.

The coupling mechanism and lighting apparatus comprising the coupling mechanism according to a preferred embodiment is defined in detail hereafter.

The coupling mechanism and lighting apparatus comprising the coupling mechanism may be configured for adjustment of the lighting apparatus to enable direction of illumination from the lighting apparatus, which is preferably a spotlight, to be adjusted over a wide angle. It is preferred that the lighting apparatus (or lighting assembly) is multi-directional whereby the angle of illumination from the lighting apparatus may be adjusted about more than one axis.

Preferably, the coupling mechanism has a first coupling member and a second coupling member for coupling with the first coupling member, which first and second coupling members may be adjustably orientated relative to one another about at least one axis and preferably about two axes. The first coupling member preferably comprises a curved strip. The second coupling member preferably comprises a retaining element for coupling with the curved strip at any of multiple positions along a length of the curved strep. The first and second coupling members are configured for magnetic coupling to one another, preferably at multiple locations along the length of the curved strips and preferably at any position along the length of the curved strip. The magnetic coupling between the first and second coupling members at multiple locations along the length of the curved strip may be derived from a series of (or multiple) discrete magnetic coupling arrangements or a continuous magnetic coupling arrangement.

Preferably, the retaining element may be capable of coupling with the curved strip at multiple discrete locations along the length of the curved strip. These multiple discrete locations may be any discrete locations on a continuum of possible discrete locations along the length of the curved strip or derived from a limited number of possible discrete locations owing to a limited number of discrete magnetic coupling arrangements.

Preferably, the retaining element and curved strip are configured for coupling at any potential location (continuously) along the length of the curved strip. Preferably, the retaining element may couple, at any one time, with the curved strip at any of multiple discrete locations along the curved strip. A discrete location may be any suitable size and may be defined by the relative sizes of the retaining element and the curved strip, but is preferably has a dimension no greater than five times the width of the curved strip, more preferably no greater than three times the width of the curved strip, e.g. from 0.5 to 2× the width of the curved strip.

The retaining element of the second coupling member and the curved strip of the first coupling member may couple, preferably magnetically, by facing coupling surfaces which, when the retaining element and curved strips are coupled, are those surfaces in contact or in closest facing arrangement to one another, since they may not be in direct contact as such (e.g. there may be a coating provided on the respective surfaces or an intervening buffer member, to reduce scratches or damage due to direct contact). A facing coupling surface of the retaining element may be any suitable shape and configuration. For example, it may be elongate and have a curve along its length (e.g. defining a concave facing coupling surface) or across its width (e.g. defining a convex facing coupling surface), it may be square or rectangular or other quadrangular or oval or triangular or circular or any other suitable shape. Optionally, the facing coupling surface may be convex (e.g. hemispherical) or concave. Optionally, it may be substantially planar. Optionally, the facing coupling surface of the retaining element and indeed the retaining element is ring-shaped, i.e. having an aperture therein e.g. to allow the passage of a power or data wire or cable from a housing of a lighting apparatus. Preferably, the facing coupling surface (and thus the retaining element) has an aperture (e.g. a circular aperture) therein for the passage of a data or power cable (e.g. an aperture of up to 10 mm, more preferably up to 5 mm or more preferably up to 3 mm and typically at least 1 mm, or at least 2 mm) and preferably the facing coupling surface is circular. The facing coupling surface may preferably be ring-shaped and preferably has a planar surface or a concave surface or part planar and part concave.

Optionally, the planar coupling surface of the retaining element is provided with a coating or a cover of resilient material, which may serve to reduce slippage as between the retaining element and curved strip and may serve to reduce contact damage. A cover may be a layer of resilient rubber or polymer foam material (e.g. of a thickness of up to 2 mm, preferably from 0.2 to 1 mm, more preferably up to 0.5 mm), whilst a coating may be a coating of a polymer material (e.g. up to 1 mm, such as from 0.05 to 0.5 mm, e.g. up to 0.2 mm).

Preferably, the retaining element has a coupling surface or facing coupling surface having a width or diameter of no more than five times the width of the curved strip, more preferably no more than three times the width and preferably in the range of half the width of the curved strip to two times the width of the curved strip and typically approximately equal to the width of the curved strip.

The retaining element may optionally be disposed in a recess of a retaining housing, which housing may be of any shape or size.

Preferably the facing coupling surface is a ring-shaped and thus defines an aperture therein and is preferably rotationally symmetrical about an axis perpendicular to the contact surface of the curved strip. Preferably, the retaining element comprises a metal or magnetic ring housed in a ring-shaped housing.

The second coupling member (or the coupling of the second coupling member to the first coupling member) is configured to provide rotational movement, e.g. for orientation about a second axis of, for example, a housing for lighting apparatus associated with the coupling mechanism. The rotational movement may be provided as between and facilitated by the coupling of the retaining element and the curved strip (in a preferred embodiment), i.e. rotation of the retaining element relative to the curved strip between the contact surfaces thereof, or may be provided by the second coupling member or retaining element elsewhere, dissociated from the coupling of the retaining element and the curved strip. This may be by a magnetic coupling, e.g. between a retaining element and a lighting mount of the second coupling member, or by non-magnetic coupling within the retaining element or between the retaining element and a lighting mount (e.g. ball and socket mounting, or bearing mount or simple rotational mount).

The curved strip of the first coupling member, as used herein, is an arrangement of material, in a strip, capable and configured to couple with the retaining element of a second coupling element. By this curved strip arrangement, the retaining element may couple with the curved strip at different positions along the length of the curved strip and thus be orientated at different respective angles to the curved strip (by virtue of the curve of the curved strip). Optionally, the strip may be configured within a body, continuous therewith or discretely formed and mounted within a body, such as the housing for a lighting apparatus as described above. The curved strip may be an arrangement of elements or components which together form a strip or may be a discrete element formed of a discrete strip of material. For example, the curved strip may comprise a series of closely arranged elements, e.g. disc members, arranged in a strip, each of which or a combination of two or more of which may be effective in coupling with a retaining element and whereby the retaining element may be coupled with the arrangement of elements at multiple locations along the length of the strip arrangement. Preferably, however, a strip may comprises a discrete length of material which is capable of coupling with a retaining element at multiple locations, preferably continuously, along the length of the strip. The strip may comprise a single length or strip of material or may comprise two or more lengths or strips of material, typically in parallel. In a particularly preferred embodiment, the strip comprises two lengths or strips of material in parallel and defining therebetween a gap of suitable size to allow passage of a cable for data or power. Thus, the gap, according to this preferred embodiment, may be up to 10 mm in width, more preferably up to 5 mm or more preferably up to 3 mm and typically at least 1 mm, or at least 2 mm.

The strip may have an exposed coupling surface in which the material of the strip is entirely exposed for coupling contact with a retaining element or may have a coating or cover or may be embedded within the material of the housing defined above, for example, whereby it is still capable of magnetic coupling with the retaining element but does not achieve direct contact therewith, other than via the coating or cover or material of the housing. The coating (e.g. of cured polymer) or cover (e.g. of rubber or polymer foam) or material of the housing (e.g. of thermoset plastic) covering the curved strip may be of any desire thickness as long as it does not disrupt the functioning, in coupling with the retaining element, of the curved strip, e.g. up to 5 mm thick, preferably up to 2 mm, optionally at least 0.05 mm or at least 0.1 mm, e.g. in the range 0.05 to 0.5 mm or more typically in the range 0.2 to 1 mm, more preferably up to 0.5 mm.

A curved strip has a length that is greater than its width. The depth or thickness of the curved strip is of no particular consequence unless it is relied upon for a property of the material of the curved strip, e.g. as a magnet, in which case it must be of sufficient depth or thickness to impart the desired property to the desired extent. The curved strip thus may be a thin layer of material (or arrangement of thinly layered elements arranged in a strip), e.g. from 0.5 to 2 mm thick or may be thicker, e.g. from 5 mm to 10 mm thick, or may be therebetween (e.g. from 2 to 5 mm). The curved strip may alternatively be provided by an edge of a larger component (e.g. disposed within a housing of a light fitting) or a plurality of protruding elements from one or more larger components, the protruding elements having outer surfaces (which themselves need not be curved) arranged to together form a curved strip. In one embodiment, the strip is defined by a planar edge or two parallel planar edges from a larger component, e.g. comprising two plate members having edges for together forming a curved strip.

Preferably, the curved strip comprises a discrete length of material or two, preferably parallel, elongate elements or lengths of material, which may be formed by the edge of a larger component (e.g. disposed within a housing of a light fitting). The two lengths of material or elongate elements may be described as rails. Preferably, they are separated by a recess (e.g. for providing passage of a wire or cable).

In one preferred embodiment, the first coupling member comprising the curved strip comprises one or a plurality (e.g. two) of plate members each having an edge (a plate edge) which one or more plate edges defined the curved strip.

The curved strip may be formed of any suitable material for coupling with the retaining element. Preferably for magnetic coupling, the curved strip is or contains a magnet or a ferromagnetic material. For example, the curved strip may comprise a polymer having a high proportion of iron powder or filings as filler (e.g. greater than 60%). Optionally, the curved strip is a strip of magnet or magnetic material. Preferably, the curved strip is an iron-containing material, e.g. an iron containing alloy, such as mild steel, which is the preferred material for the curved strip.

The curved strip may be a strip that defines a curve or part of which defines a curve. Or the curved strip may comprise more than one curve. In any case, the curved strip comprises a length defining a curve whereby positioning of a retaining element at different locations along the that length of the curve cause the retaining element to be oriented at a different angle to the curved strip as a whole and to any housing or substrate that the curved strip is attached to or associated with. Preferably, the curved strip is a strip that is curved along the entirety of its length.

The curved strip may define a longitudinal axis being an axis in a longitudinal plane of the curved strip. Preferably, the curved strip is curved along its length or, in other words, about an axis perpendicular or transverse to a longitudinal axis (or longitudinal plane) of the curved strip, the longitudinal axis or longitudinal plane being an axis or plane that is parallel with the length of the curved strip. Optionally, if the length of the curved strip follows a non-linear path (e.g. curves about an axis perpendicular to its contact surface), it may be said to define an average longitudinal axis (e.g. best fit longitudinal axis) or may have a longitudinal axis defined at any discrete position along its length.

In a preferred embodiment, the curved strip comprises a length that is straight, that is has no curves about a longitudinal axis perpendicular to the coupling surface of the curved strip.

Preferably the curved strip comprises a length that is flat across its width, that is has no or minimal curvature about its own longitudinal axis.

Preferably the curved strip is curved along its length, that is it defines a curve along its length (about an axis transverse to the longitudinal plane of the curved strip).

The curved strip may have a variable curvature or a constant curvature. The curved strip has a strip radius, which may be defined as a radius of curvature of the curved strip in the case of a strip of constant curvature or as an average (e.g. mean) radius of curvature of a curved strip of variable curvature (along a length of curved strip that is curved in the same orientation/direction).

Preferably, the curved strip has a length (or at least a length of a curved portion of the curved strip) that is at least 1× the strip radius (r), more preferably at least 1.5×r, e.g. at least 1.57×r, such as at least 1.6×r. By providing the curved strip at a length of at least 1.57×r, along which length a retaining element may be coupled with the curved strip, the coupling will allow rotation of a housing for a light apparatus mounted using the coupling of 180 degrees about one axis of orientation (that is, an axis transverse to a longitudinal plane of the curved strip) and where provided, as in a preferred embodiment, with a coupling or retaining element that facilitates rotation about a second axis (e.g. perpendicular to the contact surface of the curved strip), the coupling may further allow orientation about the second axis, e.g. of up 360 degrees. The curved strip may have a length of up to 6×r, more preferably up to 5×r and still more preferably up to 4.5×r. The curved strip may have a length of 2×r or 3×r or 4×r, for example in the range 2 to 3.5×r or 2.5 to 4×r. In any case, it is preferred that the length is in the range of 1.5 to 4.5×r and more preferably 2.5 to 3.5×r.

In combination with rotational movement, about an axis defined by the coupling surface between the curved strip and retaining element, provided by the coupling between the first and second coupling members or provided by the second coupling member or its mounting, the coupling mechanism provides for multi-directional orientation of an article mounted using the coupling mechanism, and in particular a spotlight, of, for example up to 270 degrees about a first axis of rotation and 360 degrees about a second axis of rotation, thus very simply, through a simple coupling providing very wide range of orientation for a light.

The curved strip may be of any suitable length according to the requirements and size of the coupling mechanism required. The width of the curved strip may be of any suitable width for the purpose required.

Preferably, the length is at least 2× the width, more preferably at least 3× the width, still more preferably at 4× the width, still more preferably at least 5× the width. The length may be for example up to 50× the width, but more typically up to 30× the width, and preferably up to 20× the width. Preferably, the length is from 7 to 15 times the width, e.g. 8 to 12× the width.

In one embodiment, for a domestic or commercial spotlight, e.g. roof or wall mounted, the curved strip may have a length of for example from 50 mm to 250 mm, preferably 100 to 200 mm, e.g. 120 to 150 mm, e.g. about 130 mm. The curved strip may, in one such embodiment, have a width of up to 30 mm, preferably up to 25 mm, at least 3 mm, e.g. at least 5 mm and preferably from 5 to 20, e.g. 7 to 15 mm and more preferably at least 10 mm. The radius of a curved strip in one such embodiment may be from 30 mm to 60 mm, preferably 35 to 50 mm, more preferably 40 to 45 mm.

In one preferred embodiment for a domestic or commercial lighting apparatus, the curved strip, which is preferably a strip of mild steel, has a length of from 125 to 140 mm, a width of from 8 to 15 mm and a radius of from 35 to 50 mm.

As is discussed above, in a coupling mechanism according to a preferred embodiment of the invention, the curved strip and the retaining element are configured to be adjustably orientated relative to one another about two axes. Preferably one (a first) of the two axes is an axis transverse to a longitudinal axis or longitudinal plane of the curved strip. Preferably, the retaining element comprises a facing coupling surface being that surface facing a coupling location on the curved strip when disposed in a coupled configuration with the curved strip and another (a second) of the two axes is perpendicular to the facing coupling surface of the retaining element.

In a coupling mechanism according to a preferred embodiment, one of the first coupling member (preferably the curved strip) and the second coupling member (preferably the retaining element) comprises a magnet while the other comprises a magnetic material. Preferably, the retaining element (of the second coupling element is a magnet) and the curved strip comprises (and preferably consists or consists essentially of) a ferromagnetic material, preferably mild steel.

The ferromagnetic strip and the magnetic retaining element of this preferred embodiment are selected to provide sufficient magnetic coupling strength to retain a housing according to the present invention for use in a lighting apparatus under the conditions and environment in which the light unit is used. In some embodiments a non-magnetic insert may be fitted between the magnetic strip and the retaining element to provide friction or other characteristics to the magnetic coupling. In one embodiment the addition of a thin polymeric non-magnetic insert provides friction in the coupling which assists in retention of the coupled elements in a desired angular position.

Magnetic coupling between the first coupling member (such as a mild steel curved strip) and the second coupling member (such as the retaining element) typically comprises physically retaining them together or retained in close proximity by attraction of a magnetic field. Strength of magnetic field for this purpose is typically at least partially dependent on the nature of magnetic material used in the coupling member and the amount of the magnetic material (and the size of the component—curved strip or retaining element as the case may be). At least one of the coupling members comprises a magnet.

In a preferred embodiment of the invention, the first coupling member is attached to or associated with or configured for attachment to one of the housing described above and a lighting mount and the second coupling member is attached to or associated with or configured for attachment to the other of the housing and the lighting mount. Preferably, the first coupling member is attached to or associated with or configured for attachment to the housing for a lighting apparatus.

Preferably, as mentioned above the first coupling member is attached to the housing. In a preferred embodiment, the housing comprises at least a curved outer surface portion and wherein the curvature of the outer surface portion and the curved strip are substantially similar (e.g. having radii of curvature within 30% of one another, more preferably within 20% of one another and still more preferably within 10% of one another and preferably the same). Preferably, the curved strip is disposed on, in or at the outer surface portion of the housing. In one embodiment, the curved strip is located beneath or within the surface of the housing but in such a position that enables coupling with the retaining element to be effectively achieved. In another embodiment, the curved strip is disposed on the housing, e.g. on an outside surface of the housing and defining a raised profile relative to the housing. It may be fixed thereon by any suitable means, including but not limited to adhesives and other chemical or mechanical retention means. In another, preferred, embodiment, the curved strip is disposed in relation to the housing to be flush with the surface of the housing.

The housing may be formed of any suitable metal and preferably is primarily formed of a non-ferromagnetic material, but preferably of metal suitable for cold forging. The housing preferably comprises of aluminium. Thus, it is preferable that the curved strip is distinct or distinguished from the housing on or in which it is disposed by the relative ferromagnetic nature of the materials and preferably by being ferromagnetic whilst the housing material is non-ferromagnetic.

By the provision of the curved strip on or in the housing, the housing for coupling or cooperating with a retaining element of a second coupling member associated with a mount or substrate, the angle of orientation of the housing (and thus the angle of a light beam) may be adjusted through an angled defined by the curvature and length of the curved strip, e.g. through up to 270° and preferably through at least 90°, more preferably in the range 110 to 235°, for example from 120 to 140°. By providing a curved strip on the housing that facilitates angle adjustment along its length of a particular angle, such as 120 to 140°, the arrangement can be enabled according to the choice of location of the curved strip (e.g. from close to a mouth of the housing to bisect a longitudinal plane of the housing) to facilitate effective angle adjustment of double that amount, e.g. from 240 to 280°, by virtue of a the rotation of the housing about a second axis according to the configuration of the first and second coupling member or the second coupling member.

Accordingly, the housing is preferably adjustable in angle relative to the mount about a first axis transverse to a longitudinal axis of the curved strip by coupling the curved strip to the retaining element at multiple positions along the length of the curved strip. The housing preferably is adjustable in angle relative to the mount about the first axis by at least 90°, preferably at least 120°.

Preferably, as mentioned, the housing is adjustable in angle relative to the mount about a second axis, the second axis being perpendicular to a facing coupling surface of the retaining element.

In a particularly preferred embodiment, the curved strip is disposed on or in the housing so that it extends into, through or over the heat transfer region and wherein a longitudinal axis of the curved strip is substantially parallel with the parallel fins (by substantially parallel, it is meant generally having the same planar orientation, having regard to the preferred embodiment of fins which are curved or undulating). By this arrangement, the fins of the heat sink may always be orientated such that there is a generally upward opening of the vents to ensure adequate cooling.

In one embodiment, in which the curved strip is disposed in, on or at a curved surface of the housing, the curved strip comprises two elongate members separated by a recess, whereby a power and/or data cable may be disposed through the recess.

Preferably, the retaining element comprises a magnetic ring disposed in a ring shaped housing thereby defining an aperture through which a power and/or data cable may be disposed in cooperation with a recess in the curved strip.

In a generally preferred embodiment of a housing of the invention (which features may be considered in combination or not with the coupling mechanism discussed above), the housing comprises a housing body and a peripheral insert, wherein the peripheral insert defines at least a portion of the light beam channel. In the embodiment of the invention in which the housing body comprises a core body member and a shell body member, the peripheral insert of the present embodiment may define at least a portion of the light beam channel within the core body member.

Reference is made to light fittings and components thereof in terms of their position and in particular to interior and exterior (e.g. surfaces of bodies) and inner and outer (e.g. location of components in a light fitting). By interior and exterior it is meant inside or on the inside surface of a respective defined body or outside or on the outside surface of a respective defined body. The terms interior and exterior will typically relate to lateral variations (e.g. laterally outside the body), being lateral to the beam from a light source or, for a light fitting which has a longitudinal axis corresponding to its ordinary light beam direction, lateral to the longitudinal axis. The terms inner and outer are used, generally, to refer to a position along the light beam channel (or if particularly defined in relation to a shell body member in an aperture or recess formed in the shell body member), for example, such as along the longitudinal axis thereof, such that an inner location or inner direction is considered to be toward the light source whilst an outer location or outer direction is considered to be away from the luminaire or light source or in other words in the direction of the light beam.

The peripheral insert may be of any suitable shape. It should preferably have an external surface shape to generally cooperate with a housing body into which it is inserted and an internal surface shape according to the desired shape of the light beam channel which the peripheral insert forms.

The insert is preferably removably mountable within the housing body. Thus, an insert may be substituted or changed, for example to facilitate a different optical effect (e.g. a reflective internal surface as opposed to a matt surface) or textured effect, or simply a different finish (e.g. a white finish as opposed to a black finish). The insert may also have a defined internal surface shape whereby the insert may be substituted to provide different internal surface shapes.

Preferably, in any case, the peripheral insert is an annular insert for being disposed in relation to a cylindrical internal surface of a housing body. The peripheral insert may be referred to as peripheral or annular but features thereof are considered to be generally applicable where the context allows.

It is preferred that the annular insert is removably mountable within the housing body. The annular insert may be mounted or fitted by any suitable means, e.g. a slide or friction fit or a snap fit. Preferably, the annular insert is removably mountable within the housing body by way of cooperating threads on an external surface of the annular insert and an internal surface of the housing body.

The annular insert may be disposed at any location within the light beam channel and cooperate with an internal surface of the housing at any location therein so as to define any portion of the light beam channel. For example, the insert and housing may be configured for disposal of the insert deep within the housing/light beam channel (distal to the mouth), e.g. toward an opposing end, or at a shallow position (proximal to the mouth) or in between. The annular insert may extend longitudinally by a more or less amount as desired. For example, the peripheral insert may define from 5% to 100% of the extent of the internal surface of the channel. It may extend a major portion of the length of the channel in which it is disposed (and the surface of which it may partially form), such as from 60 to 90% of the length or 70 to 80%, or a minor portion of the length, such as from 15 to 40% of the length or 20 to 30%. Preferably, however, it extends by at least 75% of the length of the channel, still more preferably at least 85% and most preferably at least 90%.

In a preferred embodiment, a lighting apparatus or housing comprises an optical mount for an optical element, such as a lens, the optical mount preferably being formed to allow the optical element to be disposed within the light beam channel (e.g. at a terminus thereof distal from the mouth) of the housing body. Preferably, the optical mount comprises a seat for supporting an optical element and a corresponding recess for receiving an optical element. Preferably, the optical element (e.g. lens) is removably mountable in the optical mount of the housing.

Preferably, the peripheral insert serves to retain the optical element in position in the optical mount, whereby the optical element may be removed by first removing the peripheral insert from the housing body.

The optical element or lens may be fixed within the housing at the mount, but is preferably removable, so that a lens of a different effect can be inserted in place thus allowing for considerable adaptability of the housing. Preferably, the lens is removable via the mouth of the housing.

Preferably, according to this general embodiment, an LED is disposed within the light beam channel within the housing at an LED mount. The LED chip is preferably screwed into position in the light beam channel and is adhered using a thermally conductive paste.

In a preferred embodiment, the annular insert is disposed so as to extend toward the inner portion of the light beam channel from the mouth and, in particular, from the rim of the mouth. Preferably, the annular insert is configured to cooperate with the housing body to form an edge or rim together with the housing body defining a rim of the mouth. Preferably, a neat fit is achieved whereby, at or near (e.g. within 2 mm of) the rim, the housing body and annular insert are separated by no more than 2 mm, more preferably no more than 1 mm, still more preferably no more than 0.5 mm and still more preferably no more than 0.2 mm. Alternatively, the annular insert comprises a flange or lip which extends laterally from one end of the annular insert and is configured to extend over or engage a rim of the housing body, e.g. a flange or lip having a lateral extent of up to 2 mm, more preferably, up to 1 mm and optionally from 0.2 to 0.8 mm.

In a preferred embodiment, the annular insert is generally tubular in shape. The annular insert preferably has a cooperating means at an end thereof distal to the mouth, as defined in situ, for cooperating with a tool for inserting or removing the insert.

Preferably, the annular insert extends from the mouth of the housing to the optical mount, or substantially to the optical mount (e.g. separated by an amount to allow a recess for receiving an annular flange of an optical element, such as up to 5 mm, preferably from 1 to 3 mm) or, where an optical element is in position, to an optical element. According to this preferred embodiment, the annular insert may define the light beam channel from the lens to the mouth.

In one embodiment, the peripheral insert comprises engaging features for facilitating or enabling cooperative inter-engagement with a corresponding engaging means of a manipulating tool or with another optical component (which for example, may be attachable or insertable into the housing body via the mouth). The engaging features may be recesses or protrusions.

In one embodiment, the peripheral insert defines an engaging recess for receiving a protrusion in a cooperating tool or other optical component. Preferably, the engaging recess, and more preferably at least two engaging recesses are provided to enable a user to engage a tool into the recesses so as to remove the insert from the housing body, for example by pulling it out (in the case of a snap or friction fit) or by twisting and unthreading (in the cases of a cooperating threaded fit). The recesses may be defined entirely within the body of the insert so as to form two or more apertures for receiving an engaging element (either from a cooperating tool or other optical component). The apertures may be disposed at any position along the length of the insert as may be desired but are preferably provided in a distal portion relative to the mouth of the housing, so as to minimize visual impact, preferably in the distal third of the insert, more preferably the distal quarter of the insert and still more preferably in the distal 10% of the insert. Optionally, as an alternative to apertures, the engaging recesses in the insert may be formed by notches formed in a distal edge of the insert.

Preferably, engaging recesses have an elongate extent or length that is circumferential (e.g. perpendicular to a longitudinal axis of the light beam channel). Preferably, the width may be up to 10 mm, preferably up to 7 mm, e.g. at least 1 mm and preferably from 2.5 to 5 mm. The length of the engaging recesses may preferably be at least 3 mm, e.g. from 5 mm to 10 mm or longer and preferably the engaging recesses are circumferentially separated from one another by at least 2 mm, more preferably at least 5 mm and still more preferably at least 10 mm. There may be any number of engaging recesses as may be required for different functions or for a single function. Preferably there are two engaging recesses disposed radially opposing one another on an annular insert.

The light fitting optionally comprises an optical accessory. The optical accessory may be any further accessory to a light fitting that affects the light beam, e.g. introduces a change to the nature of the light beam, such as its beam angle, wavelength range, incident pattern or the like. It may be, for example, a filter or a honeycomb device. Preferably, the optical accessory has a light adapting element (such as a honeycomb grid or honeycomb patterned transparent element) and an accessory body for supporting or housing the adapting element. In a preferred embodiment, the accessory body and indeed the optical accessory is adapted to removably attach to the housing via the mouth of the housing. Optionally, the optical accessory may be retained in place by way of the peripheral insert whereby the optical accessory may only be installed or removed by first removing the peripheral insert. Alternatively, and preferably, the optical accessory may be removably attached to the housing via the mouth when the peripheral insert is in place, i.e. through the mouth of the peripheral insert. In either case, the optical accessory may be adapted to attach to either or both (e.g. in a recess defined by both) of the peripheral insert and the housing body. Preferably, the optical accessory may be attached to the housing via engagement with the peripheral insert, such as via engaging features on or associated with the insert, which are preferably recesses or apertures defined therein and preferably these are releasably engaged (e.g. by push-pull fit arrangement) with resilient laterally or outwardly extending tabs disposed on the accessory body. The accessory body is preferably configured to slot into the light beam channel and the peripheral insert. Preferably, the accessory body is generally tubular and defines an accessory longitudinal axis, which when the optical accessory is disposed in a housing with the peripheral insert is generally coaxial with the peripheral insert and the light beam channel. The optical accessory may be configured so that the adapting element is disposed inside the light beam channel or extends out of the light beam channel (e.g. out of the mouth) or is disposed outside the light beam channel, but preferably is disposed within the light beam channel. If disposed in the light beam channel, the optical accessory may be configured to provide the adapting element at the mouth of the housing body (e.g. flush with the rim of the mouth) or at an inner position (at a depth) within the light beam channel, such as relatively closer to a lens (or the throat of the housing body), such as adjacent thereto. In either case, the accessory body may have a tubular shape which extends from the mouth of the housing body into the light beam channel, which accessory body optionally has an internal surface which may define at least part of the light beam channel when in situ.

As mentioned above, in a third aspect of the invention is a method of manufacturing a housing as defined above, the method comprising providing a die or mould shaped to form a moulded article corresponding to the housing, providing a metal blank and subjecting the metal blank to compressive force so as to form a housing article according to the shape of the die or mould. The metal blank is preferably cold-forged to form the housing and the metal blanks is preferably an aluminium blank and more preferably 1070 Aluminium.

In an alternative embodiment, the method of manufacturing comprises providing a die or mould shaped to form a moulded article corresponding to a core body member of a housing body, providing a metal blank and subjecting the metal blank to compressive force so as to form the core body member according to the shape of the die or mould, preferably by cold forging and more preferably with an aluminium blank such as 1070 Aluminium, forming a shell body member of the housing body and inserting the core body member into a cooperating aperture or recess in the shell body member (and preferably fusing therein). In another alternative or preferred embodiment, the method of manufacturing comprises providing a die or mould shaped to form a moulded article corresponding to a shell body member of a housing body, providing a metal blank and subjecting the metal blank to compressive force so as to form the shell body member according to the shape of the die or mould, preferably by cold forging and more preferably with an aluminium blank such as 1070 Aluminium, forming a core body member of the housing body and inserting the core body member into a cooperating aperture or recess in the shell body member (and preferably fusing therein).

The invention will now be described in more detail, without limitation, with reference to the accompanying Figures.

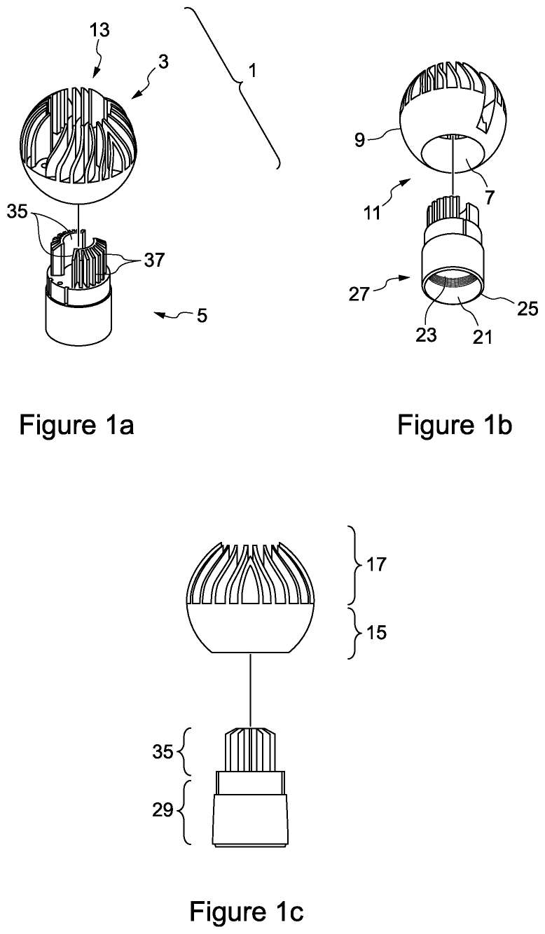

In FIGS. 1a, 1b and 1c, a housing body 1 is illustrated in exploded form showing a shell body member 3 and a core body member 5. The core body member 5 has a generally cylindrical shape and is configured to fit into aperture 7 formed in the shell body member 3. The shell body member 3 has a curved near spherical outer surface 9 with a circular aperture 7 at a proximal end 11 which extends right through the shell body member 3 to the distal end 13. A front portion 15 is formed of solid aluminium while a back portion 17 is formed of a plurality of undulating fins 19 of aluminium making up the shell heat transfer region 17 of the housing body 1. Core body member 5 has an internal surface 21 defining light beam channel 23 having mouth 25 at proximal end 27. Front portion 29 of core body member 5 defines a shallow truncated conical solid outer surface 31 which, when the core body member 5 is inserted into aperture 7 of shell body member 3, makes a contact fit with correspondingly shaped shell inner surface 33, which in use, may also facilitate heat dissipation from an LED disposed within the light beam channel 23. The back portion 35 of core body member 5 comprises core heat transfer region 35 composed of two curved elongate members 35 with outward laterally projecting elongate fins 37.

Each of the shell body member 3 and core body member 5 are formed by cold forging of 1070 grade aluminium.

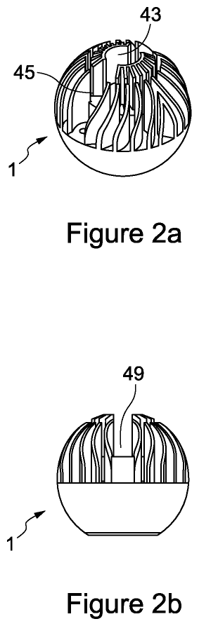

When the core body member 5 is inserted into the shell body member 3 to form housing 1 as illustrated in FIGS. 2a and 2b, the core heat transfer region 39 and shell heat transfer region 17 together form a heat transfer region 41. The curved elongate members 35, which are separated by an inner gap 43 may be aligned with an outer gap 45 formed within the undulating fins 19 in shell heat transfer region 17. These together form a plate-receiving recess 47 for receiving a plate member (not shown) for providing a coupling mechanism (not shown) described later.

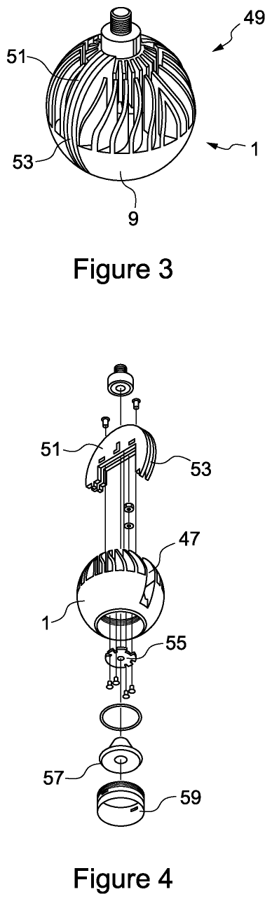

In FIG. 3, a lighting apparatus 49 is illustrated and shown in exploded view in FIG. 4. In FIG. 3, housing 1 is shown with coupling plate 51 disposed in plate receiving recess 47. The coupling plate 51, when in situ serves to provide a curved strip 53 for coupling with a magnet (not shown) in order to mount and adjust the apparatus 49. The curved strip 53 is flush with the outer surface 9 of the housing 1 and is in the form of a pair of parallel rails. The coupling plate 51 and curved strip 53 is formed of steel. Thus, the magnet may be attracted to curved strip 53 but not to the outer surface 9 of the housing body 1.

As shown in FIG. 4, in which the components of the lighting apparatus 49 are exploded, disposed within the light beam channel 23 are LED chip 55 and in front of that lens 57, which is held in position by threaded peripheral ring insert 59 (which threads into a corresponding thread on the internal surface 21 of the core body member 5). Light emanating from the LED chip 55 is transmitted from housing body 1 by way of the lens 57, threaded peripheral ring insert 59, light beam channel 23 and mouth 25.

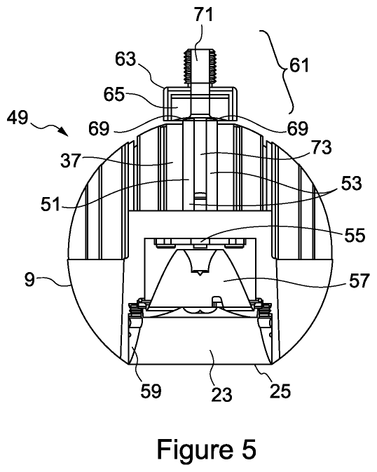

The lighting apparatus 49 is shown in a cross-sectional view in FIG. 5. Housing body 1 has curved strip 53 flush with outer surface 9 and formed by the edges of ferromagnetic steel plate 51 (which is received in the plate receiving recess 47 referred to above). Curved strip 53 forms coupling mechanism 61 together with second coupling member 63 consisting of ring-shaped magnet 65 encased in magnet holder 67, which allows coupling of the magnet 65 via magnet surfaces 69 along any location of curved strip 53, thereby allowing adjustment of the angle of the light beam channel 23 and thereby of the light emitted by the apparatus 49. The coupling mechanism 49 also allows the housing 1 to be rotated in its coupling about the axis of ring-shaped magnet 65 providing a second dimension of adjustment. An electrical cable (not shown) for providing electrical power to LED chip 55 may pass through cable passage 71 passing through the centre of magnet holder 63 and magnet 65 and into a plate gap 73 between the two tracks of curved strip 53. Laterally projecting fins 37 of the core heat transfer region 39 extend back from and in thermally conductive contact with the LED chip 55 which is mounted light beam channel 23 distal from mouth 25. Disposed in front of LED chip 55 is lens 57, which is secured in place by peripheral ring insert 59, the outer edge of which is flush with mouth 25 and outer surface 9.

### EXAMPLE

Two lighting apparatus were prepared having the configuration in FIG. 3. A first housing was prepared in a single unit by CNC using 6082 Aluminium. A second housing was made in two parts by the method described herein by cold-forging a core and shell of 1070 Aluminium in a die and inserting the core into the shell. The first and second housings have the same overall dimensions.

An assessment of the thermal dissipation performance of light fittings having the first housing and the second housing was carried out in ambient air temperature of 45° C. The results are set out in Table 1 below.

TABLE 1

| | Housing 1 | Housing 2 |
|---|---|---|
| Max temp. of light source | 100.44° C. | 89.86° C. |
| Max temp. of heatsink | 89.70° C. | 84.88° C. |

Housing 2 (made using core and shell parts by cold forging) reduces LED temperature by approximately 10%.

The invention has been described with reference to a preferred embodiment. However, it will be appreciated that variations and modifications can be effected by a person of ordinary skill in the art without departing from the scope of the invention.

1. A housing for a lighting apparatus, the housing having a housing body comprising a light beam channel for the passage of light from a light source through the housing to a mouth, the light beam channel being defined by an internal surface of the housing body, the housing having a light source or a light source mount within the light beam channel, wherein the housing body has a front portion proximal to the mouth and a back portion distal from the mouth and, formed integrally with the housing body and disposed at a back portion of the housing body, a heat transfer region, wherein at least a portion of the housing body is formed of forged metal, wherein the housing body comprises a core body member and a shell body member, wherein the core body member comprises the light beam channel, which light beam channel is defined by an internal surface of the core body member, and a light source or light source mount within the light beam channel and wherein the core body member comprises a core heat transfer region and wherein the shell body member comprises an aperture for securely receiving the core body member and comprises a shell heat transfer region.

2. The housing according to claim 1, wherein at least a portion of the housing body is formed of cold forged metal.

3. The housing according to claim 1, wherein the metal is aluminium.

4. The housing according to claim 3, wherein the aluminium is 1070 aluminium.

5. The housing according to claim 1, wherein the heat transfer region comprise heat transfer members separated by air gaps to provide enhanced heat transfer surface area and to facilitate convective cooling.

6. The housing according to claim 5, wherein the heat transfer region comprises fins that are planar, curved, undulating or a combination thereof.

7. The housing according to claim 5, wherein the peripheral ends or surface of the heat transfer members define an outer surface of a back portion of the housing body.

8. The housing according to claim 1, wherein the heat transfer region extends to a distal end of the housing body from a position closer to the mouth than the light source or light source mount is from the mouth.

9. The housing according to claim 8, wherein the heat transfer region comprises fins that extend from a position closer to the mouth than the light source or light source mount is from the mouth.

10. The housing according to claim 1, wherein the light source or light source mount is disposed at an opposite end of the channel from the mouth.

11. The housing according to claim 1, wherein the path of the light beam channel from light source or light source mount defines a longitudinal axis of the housing body, wherein a heat transfer region extends from a portion of the housing body transverse to the light beam channel and in thermal connection with the internal surface of the housing body defining the light beam channel to a distal end of housing body distal to the mouth of the light beam channel.

12. The housing according to claim 1, wherein the core heat transfer region is integral with the core body member and the shell heat transfer region is integral with the shell body member.

13. The housing according to claim 1, wherein at least the shell body member is formed of forged metal.

14. The housing according to claim 13, wherein both the shell body member and the core body member are formed of forged metal.

15. The housing according to claim 1, wherein the light source is an LED.

16. A method of manufacturing a housing as defined in claim 1, the method comprising providing a die or mould shaped to form a moulded article corresponding to the housing, providing a metal blank and subjecting the metal blank to compressive force so as to form a housing article according to the shape of the die or mould.

17. The method of manufacturing according to claim 16, wherein the housing is cold forged from the metal blank.

18. The method of manufacturing according to claim 16, wherein the metal blank is an aluminium blank.
